(19) United States
(12) Patent Application Publication
(10) Pub. No.: US 2020/0040670 A1
(43) Pub. Date: Feb. 6, 2020

(54) CENTRIFUGAL VALVE

(71) Applicants: Joshua Raymond Snitkoff, Houston, TX (US); Robert O'Brien, Katy, TX (US); Larry Palmer, Spring, TX (US); Joeri Van Hove, Cypress, TX (US)

(72) Inventors: Joshua Raymond Snitkoff, Houston, TX (US); Robert O'Brien, Katy, TX (US); Larry Palmer, Spring, TX (US); Joeri Van Hove, Cypress, TX (US)

(73) Assignee: Baker Hughes, a GE company, LLC, Houston, TX (US)

(21) Appl. No.: 16/527,747

(22) Filed: Jul. 31, 2019

Related U.S. Application Data
(60) Provisional application No. 62/713,304, filed on Aug. 1, 2018.

(51) Int. Cl. E21B 17/10; F16K 25/04; F16K 41/12

(52) U.S. Cl. CPC E21B 17/10; E21B 21/103; F16K 41/125; F16K 25/04

(57) ABSTRACT

A debris management tool including a housing; an opening in the housing; a closure member movable between a closed position and an open position based upon centrifugal input. A method for managing debris in a borehole including rotating the tool as in any prior embodiment at a selected speed to cause centrifugal force to open the closure member; increasing pressure in a fluid surrounding the tool; entraining debris in fluid entering the tool due to differential pressure.

### CROSS REFERENCE TO RELATED APPLICATIONS

This application claims the benefit of an earlier filing date from U.S. Provisional Application Ser. No. 62/713,304 filed Aug. 1, 2018, the entire disclosure of which is incorporated herein by reference.

### BACKGROUND

In the resource recovery industry debris in the form of rock cuttings, metal cuttings, sand, etc. tends to be generated in the downhole environment. All of this debris is harmful to equipment and can have a negative effect on production. Any means to reduce such debris would be welcomed by the art.

### SUMMARY

A debris management tool including a housing; an opening in the housing; a closure member movable between a closed position and an open position based upon centrifugal input.

A method for managing debris in a borehole including rotating the tool as in any prior embodiment at a selected speed to cause centrifugal force to open the closure member; increasing pressure in a fluid surrounding the tool; entraining debris in fluid entering the tool due to differential pressure.

### BRIEF DESCRIPTION OF THE DRAWINGS

The following descriptions should not be considered limiting in any way. With reference to the accompanying drawings, like elements are numbered alike:

FIG. 1 is a rotate-to-actuate tool as disclosed herein in a closed position;

FIG. 2 is the view of FIG. 1 with the tool in the open position;

FIG. 3 is another embodiment of a rotate-to-actuate as disclosed herein in a closed position;

FIG. 4 is the embodiment of FIG. 3 with the tool in the open position;

FIG. 5 is a perspective view of another embodiment of a rotate-to-actuate tool as disclosed herein in a closed position;

FIG. 6 is a cross section of the embodiment of FIG. 5; and

FIG. 7 is the embodiment of FIG. 5 with the tool in the open position.

### DETAILED DESCRIPTION

A detailed description of one or more embodiments of the disclosed apparatus and method are presented herein by way of exemplification and not limitation with reference to the Figures.

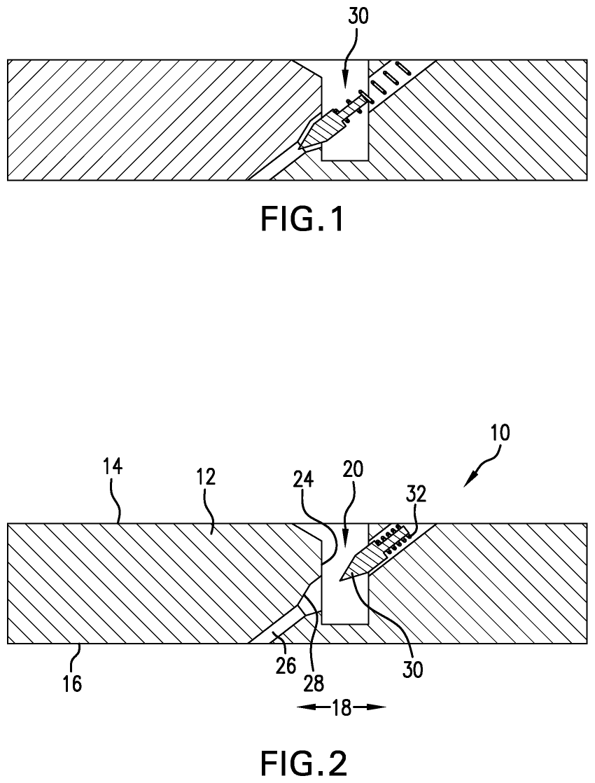

Referring to FIGS. 1 and 2 simultaneously, an embodiment of a debris management tool 10 employing a valve is illustrated. Tool 10 comprises a housing 12 having an outer surface 14 and an inner surface 16 that defines a passage 18. In embodiments, the housing 12 is a tubular member such as a casing, drill pipe or a part of a tubing string and the passage 18 would be colloquially termed the ID. Disposed through the housing 12 is an opening 20. A closure member 22 is positionable to close the opening 20 or open the opening 20. The closure member 22 is configured to be responsive to centrifugal force in that in an embodiment, rotation of the housing 12 at a selected speed or greater will cause the closure member to move. In some embodiments the movement of the closure member under the impetus of rotation of the housing will be to the open position while in others, the tool operation may be reversed. In either case, the tool will become a reservoir for debris in the vicinity of the tool when the closure member 22 is opened and pressure outside of the tool is greater than pressure inside the tool. Due to a pressure differential across the closure member, once the member 22 is opened, fluid will rush into the tool entraining debris with that fluid and become trapped there when the closure member 22 is closed.

In the particular illustration of FIGS. 1 and 2, the opening 20 comprises a radial component 24 that extends partially through housing 12 from outside surface 14 to a point between outside surface 14 and inside surface 16. A conduit 26 intersects radial component 24, extending from radial component 24 to the inside surface 16 thus making the combination of radial component 24 and conduit 26 define a fluid path from outside surface 14 to inside surface 16. Conduit 26 also comprises a seat 28. The seat is receptive to a seal 30 that is biased by a biasing member 32 into contact with the seat 28 to block the fluid path of radial component 24 and conduit 26. The biasing member 32 may be a coil spring or any other configuration or material that provides a biasing force. In this embodiment, the elements just described comprise the closure member 22. In FIG. 1, the seal 30 is nested with seat 28 and the opening 20 is closed; in FIG. 2, the housing 12 is being rotated at a selected rotations per minute or greater resulting in the seal 30 coming off the seat 28 and allowing fluid (with entrained debris) to rush through the opening 20 into the ID of the tool 10.

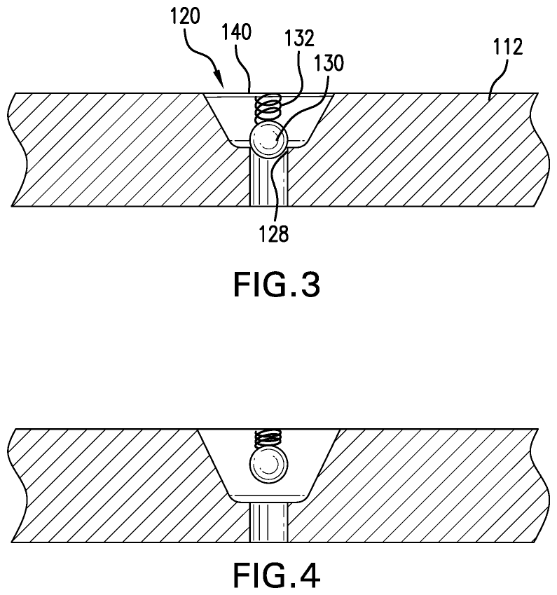

In another embodiment, referring to FIGS. 3 and 4, and wherein like elements that are not identical to the foregoing but are similar are identified with one hundred series numerals, the opening 120 still ultimately creates a fluid path through the housing 112 but does so with a directly radial movement of seal 130 making the tool 110 more sensitive to rotational input. In this embodiment, the biasing member 132 requires structure 140 extending from housing 112 to bear against. With rotational input at a selected rate or higher, the seal 132 will move radially outwardly off seat 128 compressing the biasing member 132 (collectively the closure member 122) and allow fluid to flow across the opening 120, which in an embodiment will be into the tool in order to trap entrained debris as noted above under the same conditions of differential pressure. The seal 132 will again seat on the seat 128 with reducing rotational input below a threshold level associated with a centrifugal effect being greater than the spring force of the biasing member 132. The debris will thence again in this embodiment become trapped in the tool 110.

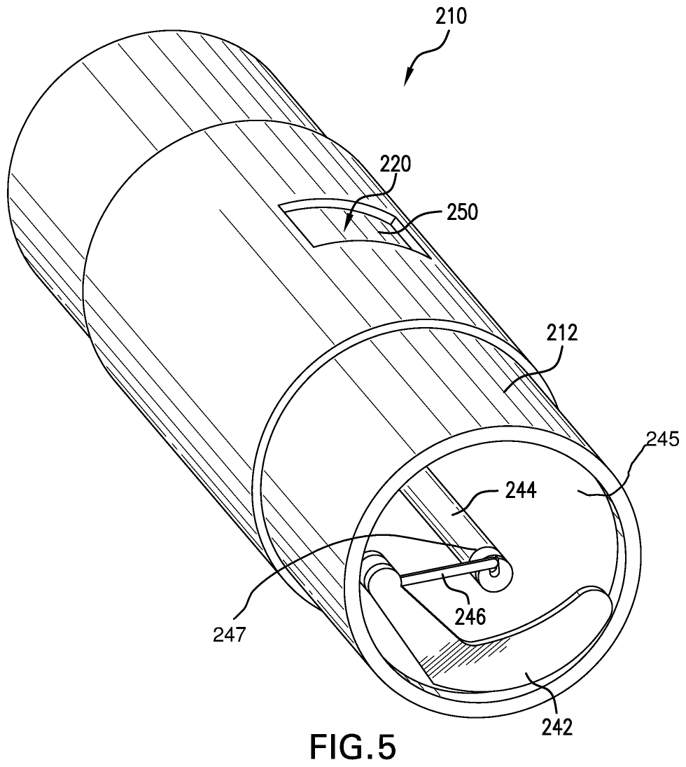

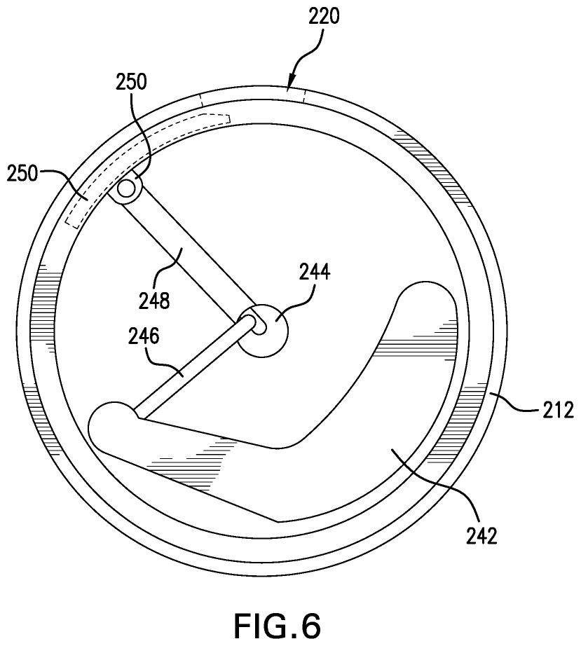

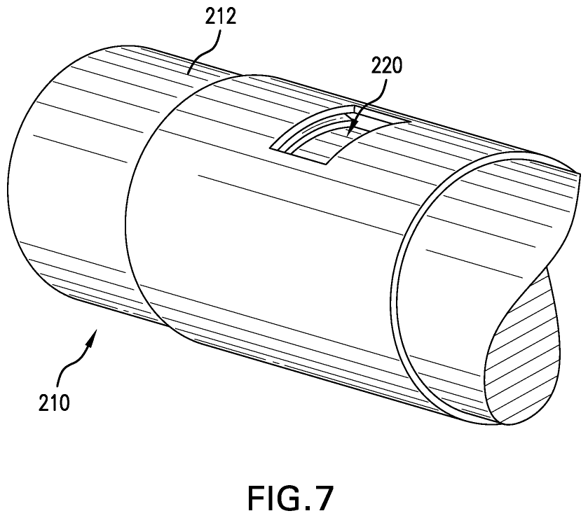

In yet another embodiment, referring to FIGS. 5, 6 and 7, a tool 220 includes a housing 212 having an opening 220. The closure member 222 for this embodiment comprises more elements than the foregoing embodiments, to wit, an eccentric member 242, a pivot shaft 244, a connector 246 articulating the pivot shaft 244 and fixedly connected to the eccentric member 242, a door connector 248, a door interface 250 and a door 252 all comprise the closure member 222. In some embodiments the eccentric member 242 may rest against a plate 245 spanning the housing 212. Also in some embodiments, the closure member 222 will include a torsion spring 247 located to urge the eccentric member 242 to a position associated with the closure member 222 being in a particular (closed or open) position in the absence of a threshold rotating input and to be overcome to allow the closure member 222 to move to the opposite position (open or closed) when the threshold rotational input is applied. When the threshold is applied the closure member 222 cause the door 252 to slide perimetrically of the housing 212 to either close or open the opening 220. When the door 252 is open and in the condition of pressure differential across the opening 220 as described above, fluid and debris will flow into the tool 210 and then be trapped therein when the door 252 is closed.

Set forth below are some embodiments of the foregoing disclosure:

### Embodiment 1

A debris management tool including a housing; an opening in the housing; a closure member movable between a closed position and an open position based upon centrifugal input.

### Embodiment 2

The tool as in any prior embodiment wherein the centrifugal force uncovers the opening.

### Embodiment 3

The tool as in any prior embodiment wherein the centrifugal force covers the opening.

### Embodiment 4

The tool as in any prior embodiment wherein the opening is a passageway through the housing.

### Embodiment 5

The tool as in any prior embodiment wherein the passageway includes a radial component.

### Embodiment 6

The tool as in any prior embodiment wherein the closure member moves radially outwardly from a closed position to an open position.

### Embodiment 7

The tool as in any prior embodiment wherein the radial component extends partially through the housing and an intersecting conduit extends from the radial component to an inside surface of the housing.

### Embodiment 8

The tool as in any prior embodiment wherein the closure member includes a seal nestable in a seat of the intersecting conduit.

### Embodiment 9

The tool as in any prior embodiment wherein the seal is biased to the nested position.

### Embodiment 10

The tool as in any prior embodiment wherein the seal is biased by a spring.

### Embodiment 11

The tool as in any prior embodiment wherein the closure member is a door.

### Embodiment 12

The tool as in any prior embodiment wherein the door is slidable perimetrically of the housing between the closed and open positions.

### Embodiment 13

The tool as in any prior embodiment wherein the tool further includes a pivot shaft and an eccentric member responsive to centrifugal force input, the eccentric member being connected to the door such that movement of the eccentric member causes movement of the door.

### Embodiment 14

The tool as in any prior embodiment, the tool further comprising a biaser configured and positioned to move the eccentric member opposite the direction of movement caused by centrifugal force input.

### Embodiment 15

A method for managing debris in a borehole including rotating the tool as in any prior embodiment at a selected speed to cause centrifugal force to open the closure member; increasing pressure in a fluid surrounding the tool; entraining debris in fluid entering the tool due to differential pressure.

### Embodiment 16

The method as in any prior embodiment further including reducing rotational speed of the housing; closing the closure member; and trapping the debris inside the tool.

### Embodiment 17

A valve including a housing, an opening defined by the housing, a closure member positionable to open the opening or close the opening, the closure member being biased in a direction of closed or open and responsive to centrifugal force to overcome the bias.

### Embodiment 18

The valve as in any prior embodiment wherein the closure member exhibits a threshold force beyond which the bias is overcome.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A debris management tool comprising:
a housing;
an opening in the housing;
a closure member movable between a closed position and an open position based upon centrifugal input.

2. The tool as claimed in claim 1 wherein the centrifugal force uncovers the opening.

3. The tool as claimed in claim 1 wherein the centrifugal force covers the opening.

4. The tool as claimed in claim 1 wherein the opening is a passageway through the housing.

5. The tool as claimed in claim 1 wherein the passageway includes a radial component.

6. The tool as claimed in claim 1 wherein the closure member moves radially outwardly from a closed position to an open position.

7. The tool as claimed in claim 5 wherein the radial component extends partially through the housing and an intersecting conduit extends from the radial component to an inside surface of the housing.

8. The tool as claimed in claim 7 wherein the closure member includes a seal nestable in a seat of the intersecting conduit.

9. The tool as claimed in claim 8 wherein the seal is biased to the nested position.

10. The tool as claimed in claim 9 wherein the seal is biased by a spring.

11. The tool as claimed in claim 1 wherein the closure member is a door.

12. The tool as claimed in claim 11 wherein the door is slidable perimetrically of the housing between the closed and open positions.

13. The tool as claimed in claim 11 wherein the tool further includes a pivot shaft and an eccentric member responsive to centrifugal force input, the eccentric member being connected to the door such that movement of the eccentric member causes movement of the door.

14. The tool as claimed in claim 13, the tool further comprising a biaser configured and positioned to move the eccentric member opposite the direction of movement caused by centrifugal force input.

15. A method for managing debris in a borehole comprising:
rotating the tool as claimed in claim 1 at a selected speed to cause centrifugal force to open the closure member;
increasing pressure in a fluid surrounding the tool;
entraining debris in fluid entering the tool due to differential pressure.

16. The method as claimed in claim 15 further comprising:
reducing rotational speed of the housing;
closing the closure member; and
trapping the debris inside the tool.

17. A valve comprising:
a housing;
an opening defined by the housing;
a closure member positionable to open the opening or close the opening, the closure member being biased in a direction of closed or open and responsive to centrifugal force to overcome the bias.

18. The valve as claimed in claim 17 wherein the closure member exhibits a threshold force beyond which the bias is overcome.
